(19) United States
(12) Patent Application Publication
(10) Pub. No.: US 2008/0106396 A1
(43) Pub. Date: May 8, 2008

(54) SIGNAL LIGHT FOR VEHICLE SIDE-VIEW MIRROR

(76) Inventor: Yu-Te Hsieh, Chang-Hua Hsien (TW)

Correspondence Address: LACKENBACH SIEGEL, LLP, LACKENBACH SIEGEL BUILDING, 1 CHASE ROAD, SCARSDALE, NY, 10583, US

(21) Appl. No.: 11/927,133

(22) Filed: Oct. 29, 2007

(30) Foreign Application Priority Data
Nov. 3, 2006 (TW) 095219435

(51) Int. Cl. B60Q 1/34

(52) U.S. Cl. 340/475

(57) ABSTRACT

A vehicle signal light includes a housing, a light-guiding unit, a light-emitting unit, and a light shield. The housing has a rear wall and a transparent front wall. The light-guiding unit is mounted in the housing, and includes a light-transmitting member and a refractive member. The light-transmitting member has front, rear, and first and second side surfaces. The refractive member includes first protrusions formed on the rear surface. The light-transmitting member and the refractive member are made of a light-transmissive material. The light-emitting unit is disposed proximate to the first and second side surfaces of the light-transmitting member, and emits light into the light-transmitting member. The light shield is disposed adjacent to the rear surface and reflects light emitted thereon toward the housing front wall.

### CROSS-REFERENCE TO RELATED APPLICATION

This application claims priority of Taiwanese Application No. 095219435, filed on Nov. 3, 2006.

### BACKGROUND OF THE INVENTION

1. Field of the Invention

This invention relates to a vehicle signal light, and more particularly, to a signal light for use on a vehicle side-view mirror that provides superior illumination and that reduces battery power consumption.

2. Description of the Related Art

A signal light mounted on a side-view mirror of a vehicle is used as an advanced notification to other drivers that the operator of the vehicle intends to turn or change lanes. By operating the signal light, vehicle collision can be possibly avoided, and thus, driving safety is enhanced.

Referring to FIGS. 1 and 2, a conventional signal light 1 is provided in a side-view mirror 10 of a vehicle 100. The signal light 1 is designed to follow the external contour shape of the side-view mirror 10, and includes a housing 11 and a plurality of equally spaced-apart light-emitting diode (LED) lamps 12 disposed within the housing 11. The housing 11 includes a base 111 and a transparent cove 2 that cooperate to define a compartment space 113. A reflective layer 114 for light reflection is formed on the base 111 of the housing 11. The LED lamps 12 are disposed on or embedded in the reflective layer 114 of the base 111 so that light emitted from the LED lamps 12 is reflected and scattered by the reflective layer 114.

Although the signal light 1 is able to realize signaling as intended, the signal light 1 still has the following drawbacks:
1) The housing 11 must contain a significant number of the LED lamps 12 in order to allow light to be uniformly and brightly projected through the transparent cover 112. This increases manufacturing costs.
2) The presence of such a large number of the LED lamps 12 consumes a considerable amount of battery power.

### SUMMARY OF THE INVENTION

Therefore, it is an object of the present invention to provide a vehicle signal light that is capable of overcoming the above-mentioned drawbacks of the prior art.

According to the present invention, the vehicle signal light includes a housing, a light-guiding unit, a light-emitting unit, and a light shield. The housing has a rear wall and a transparent front wall. The light-guiding unit is mounted in the housing and includes a light-transmitting member that has a front surface adjacent to the front wall, a rear surface opposite to the front surface, and first and second side surfaces each interconnecting the front and rear surfaces, and a refractive member disposed on the rear surface of the light-transmitting member. The refractive member includes a plurality of first protrusions formed on the rear surface of the light-transmitting member. The light-transmitting member and the refractive member are made of a light-transmissive material. The light-emitting unit is disposed in the housing proximate to at least one of the first and second side surfaces of the light-transmitting member. The light-emitting unit emits light into the light-transmitting member. The light shield is disposed in the housing adjacent to the rear surface of the light-transmitting member and reflects light emitted thereon toward the front wall of the housing.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a vehicle having a conventional signal light mounted on a side-view mirror thereof;

FIG. 2 is a top, partly sectional view of the side-view mirror of FIG. 1;

FIG. 3 is a side view of the preferred embodiment of a signal light according to the present invention, illustrating the signal light in a state mounted in a side-view mirror;

FIG. 4 is a top, partly sectional view of the side-view mirror of FIG. 3; and

FIG. 5 is a view similar to FIG. 4, but illustrating a modified example of the preferred embodiment.

### DETAILED DESCRIPTION OF THE PREFERRED EMBODIMENT

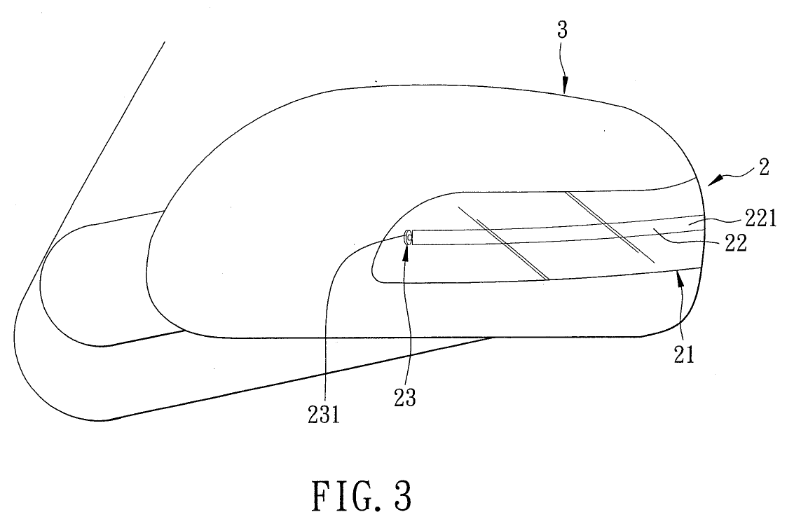

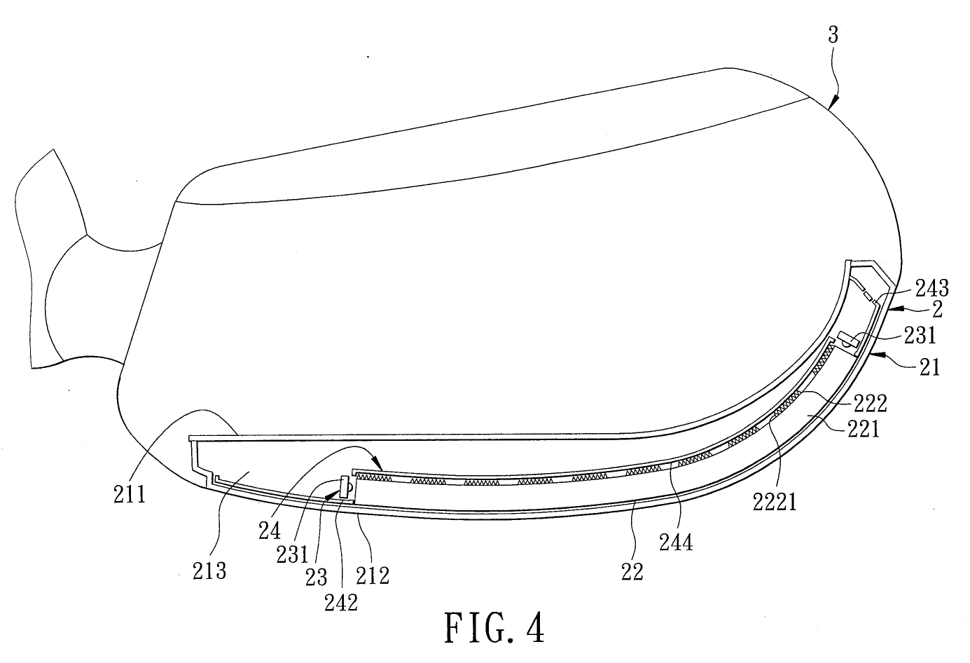

Referring to FIGS. 3 and 4, the preferred embodiment of a vehicle signal light 2 according to the present invention is provided in a side-view mirror 3 of a vehicle. The vehicle signal light 2 includes a housing 21, a light-guiding unit 22, a light-emitting unit 23, and a light shield 24.

The housing 21 has a rear wall 211 and a transparent front wall 212. The rear wall 211 and the transparent front wall 212 are assembled together and cooperate to define a compartment space 213.

The light-guiding unit 22 is mounted in the housing 21, and includes a light-transmitting member 221 that has a front surface adjacent to the front wall 212, a rear surface opposite to the front surface, and first and second side surfaces each interconnecting the front and rear surfaces. The light-guiding unit 22 further includes a refractive member 222 disposed on the rear surface of the light-transmitting member 221. The refractive member 222 includes a plurality of first protrusions 2221 formed on the rear surface of the light-transmitting member 221. The light-transmitting member 221 and the refractive member 222 are made of a light-transmissive material.

The light-emitting unit 23 is disposed in the housing 21 proximate to at least one of the first and second side surfaces of the light-transmitting member 221. The light-emitting unit 23 emits light into the light-transmitting member 221.

The light shield 24 is disposed in the housing 21 adjacent to the rear surface of the light-transmitting member 221 and reflects light emitted thereon toward the front wall 212 of the housing 21.

In the preferred embodiment, the refractive member 222 of the light-guiding unit 22 is formed as a single piece with the light-transmitting member 221. However, the refractive member 222 and the light-transmitting member 221 are not required to be made as a single piece, and instead, may be separately formed and joined together by means of an adhesive or any other connecting means.

In the preferred embodiment, the light-emitting unit 23 includes a pair of light-emitting diodes 231 that are disposed respectively proximate to the first and second side surfaces of the light-transmitting member 221.

The light shield 24 has a reflective surface 244 adjacent to the rear surface of the light-transmitting member 221. Further, in the preferred embodiment, the light shield 24 includes a pair of auxiliary light-shielding elements 242, 243 that are disposed respectively adjacent to the first and second side surfaces of the light-transmitting member 221.

In the preferred embodiment, each of the light-transmitting member 221 and the refractive member 222 is made from a polycarbonate (PC) material, a polymethyl methacrylate (PMMA) material, or a material similar to PC and PMMA.

In use, the light-emitting unit 23 emits light into the light-transmitting member 221. Due to the presence of the reflective surface 244 and the refractive member 222 which are disposed respectively on the light shield 24 and on the rear surface of the light-transmitting member 221, light that is not directly transmitted through the light-transmitting member 221 and out the front wall 212 of the housing 21 is first reflected off the reflective surface 244 and thereafter, the reflected light is refracted through the refractive member 222. Hence, the light that undergoes such reflection and refraction is more fully and uniformly dispersed, and is projected outwardly through the front wall 212 of the housing 21 in this state of greater dispersion. In addition, through the presence of the auxiliary light-shielding elements 242, 243, light is better focused through the transparent front wall 212 of the housing 21. As such, light can be spread uniformly over a larger area and also produce brighter illumination.

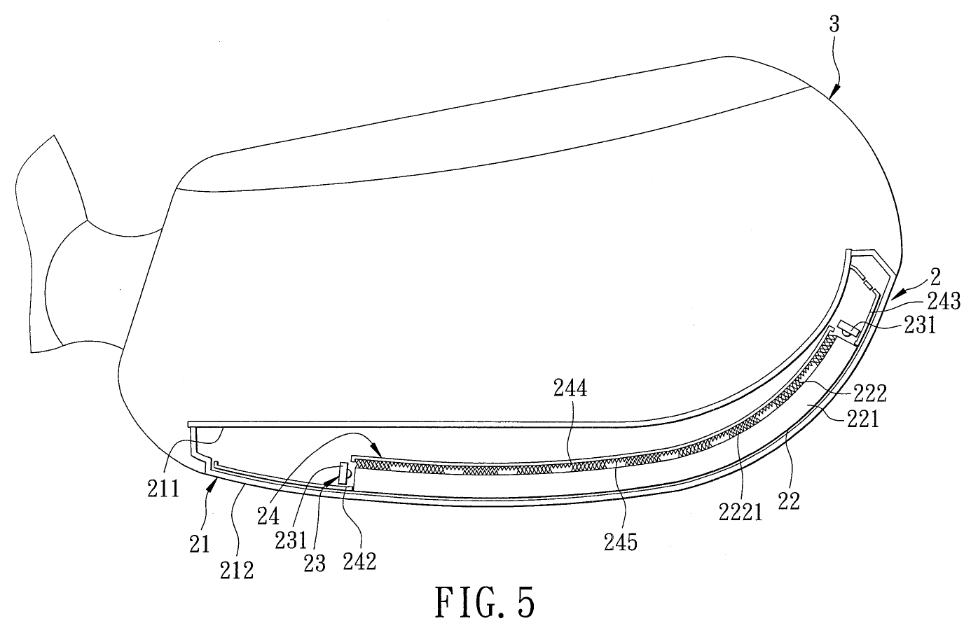

Reference is now made to FIG. 5, which shows a modified example of the preferred embodiment. In this modified example, a plurality of second protrusions 245 are formed on the reflective surface 244 of the light shield 24 to enhance the reflective capability of the light shield 24. Further, in this modified embodiment, light is reflected off the second protrusions 245 instead of reflecting off the reflective surface 244 as described above.

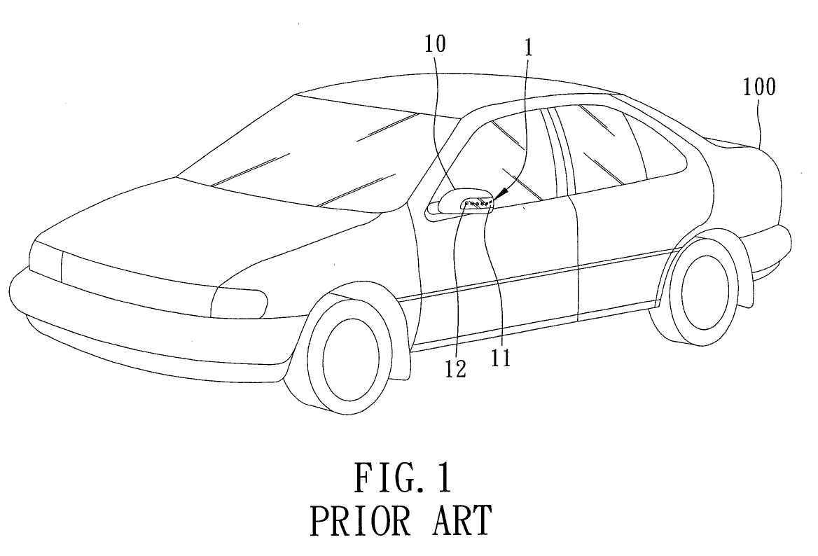

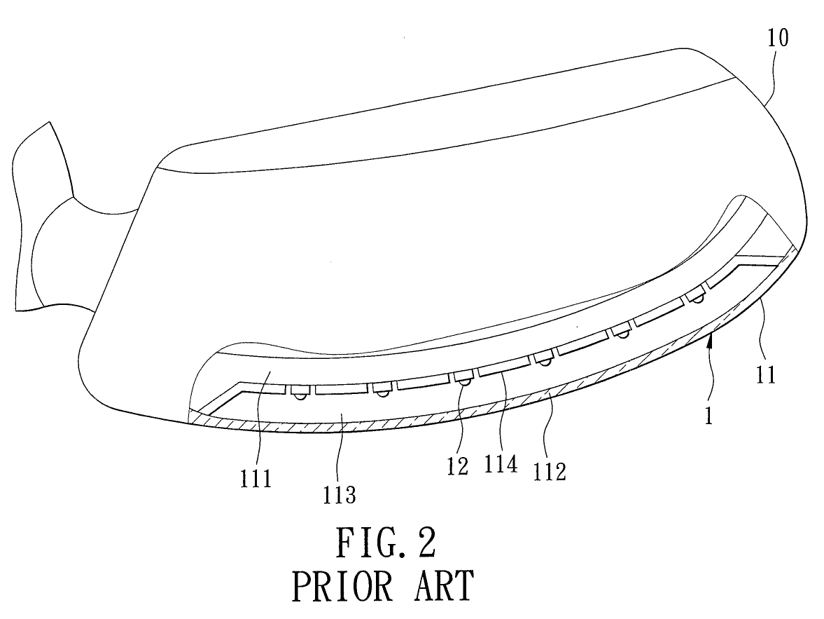

The advantages that can be obtained by the present invention are as follows:
1) The present invention allows for a reduction in the number of the light-emitting diodes 231 when compared to the conventional configuration shown in FIGS. 1 and 2, which requires 5 or 6 LEDs. Hence, the cost of manufacture decreases accordingly.
2) Due to such a reduction in the number of the light-emitting diodes 231, battery consumption is also decreased.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A vehicle signal light, comprising:
a housing having a rear wall and a transparent front wall;
a light-guiding unit mounted in said housing, and including
a light-transmitting member having a front surface adjacent to said front wall, a rear surface opposite to said front surface, and first and second side surfaces each interconnecting said front and rear surfaces, and
a refractive member disposed on said rear surface of said light-transmitting member, said refractive member including a plurality of first protrusions formed on said rear surface,
said light-transmitting member and said refractive member being made of a light-transmissive material;
a light-emitting unit disposed in said housing proximate to at least one of said first and second side surfaces of said light-transmitting member, said light-emitting unit emitting light into said light-transmitting member; and
a light shield disposed in said housing adjacent to said rear surface of said light-transmitting member, said light shield reflecting light emitted thereon toward said front wall of said housing.

2. The vehicle signal light of claim 1, wherein said refractive member of said light-guiding unit is formed as a single piece with said light-transmitting member.

3. The vehicle signal light of claim 1, wherein said light-emitting unit includes a pair of light-emitting diodes disposed respectively proximate to said first and second side surfaces of said light-transmitting member.

4. The vehicle signal light of claim 1, wherein said light shield has a reflective surface adjacent to said rear surface of said light-transmitting member, said light shield including a plurality of second protrusions formed on said reflective surface.

5. The vehicle signal light of claim 1, wherein said light shield includes a pair of auxiliary light-shielding elements disposed respectively adjacent to said first and second side surfaces of said light-transmitting member.

6. The vehicle signal light of claim 1, wherein each of said light-transmitting member and said refractive member is made from one of a polycarbonate (PC) material and a polymethyl methacrylate (PMMA) material.
